(19) United States
(12) Patent Application Publication
(10) Pub. No.: US 2007/0211271 A1
(43) Pub. Date: Sep. 13, 2007

(54) Process control strip and recording method

(75) Inventor: Thomas Kohler, Hartenstein (DE)

Correspondence Address: LERNER GREENBERG STEMER LLP, P O BOX 2480, HOLLYWOOD, FL, 33022-2480, US

(73) Assignee: Heidelberger Druckmaschinen AG

(21) Appl. No.: 11/703,473

(22) Filed: Feb. 7, 2007

(30) Foreign Application Priority Data
Mar. 10, 2006 (DE) 10 2006 011 140.0

(51) Int. Cl. G06F 15/00

(52) U.S. Cl. 358/1.9

(57) ABSTRACT

A process control strip, for the visual checking of an exposure process for a recording material, includes coarse signal elements having a size which is substantially constant in the event of process fluctuations, and fine signal elements having a size which changes in the event of process fluctuations. In known process control strips, a dependence of the visual perception of the tone values of the coarse signal elements from the position of an observer in relation to a preferential direction of the coarse signal elements which is predetermined by the direction of propagation of lines, has been found. This angular dependence of the impression is overcome by providing at least one first region with coarse signal elements in the form of a line raster with lines which have a course different from a straight line.

### CROSS-REFERENCE TO RELATED APPLICATION

This application claims the priority, under 35 U.S.C. §119, of German Patent Application DE 10 2006 011 140.0, filed Mar. 10, 2006; the prior application is herewith incorporated by reference in its entirety.

### BACKGROUND OF THE INVENTION

### Field of the Invention

The invention relates to the field of electronic reproduction technology and refers to a process control strip for the visual checking and calibration of an exposure process for a recording material, in particular for a printing plate. The invention also relates to a method for recording the process control strip.

The dot and line screened exposure of a recording material, for example a printing plate, conventionally takes place through the use of an electronic recording appliance, also referred to as a plate imagesetter or recorder. For that purpose, image data representing the tone values to be recorded are fed to a raster generator, that is to say a raster image processor (RIP), in which the image data are converted according to a raster function into control signal values for an exposure beam generated in an exposure unit of the imagesetter. During a relative movement between the exposure beam and the printing plate to be exposed, the dot and line exposure of the plate takes place, in such a way that the control signal values switch the exposure beam on and off and consequently determine which dots, often also designated as pixels, are exposed or are not exposed as parts of the raster dots on the printing plate. The raster function in that case defines the size of the raster dots as a function of the tone values to be recorded. In the exposure of a printing plate in a plate imagesetter, the relative movement takes place, for example, in such a way that the printing plate is tension-mounted on a printing plate cylinder and is moved in rotation under an exposure head having the exposure optics, thereby defining what is known as the fastscan direction of exposure on the printing plate. During the rotation of the printing plate, the exposure head is moved in what is known as the slowscan direction. Alternatively, the printing plate may also be tension-mounted immovably inside an indrum imagesetter. The exposure beam is then deflected linearly onto the surface of the printing plate through the use of rotating optics. The optics are moved along an axis in the slowscan direction in order to expose the entire surface.

During the exposure of the printing plate, the tone values or raster dot sizes actually generated on the plate deviate from the desired nominal tone values, since each pixel and consequently each raster dot is recorded, increased or else reduced in size to a greater or lesser extent, due to glare and influences of a development process following the exposure. The deviations between the tone values actually generated and the nominal tone values are designated as dot growths which lead to disturbing changes in tone value in the reproduction.

The dot growths are therefore compensated during the printing plate exposure in the imagesetter, in that the image signal values which represent the nominal tone values are corrected, according to a correction curve determined before printing plate exposure, by what is known as a linearization of the imagesetter, in such a way that the tone values actually recorded on the printing plate correspond to the nominal tone values or to target tone values reproducible in a defined way.

After printing plate exposure, the plate exposed in the imagesetter is developed in a development station. However, processless plates are also known, which can be used without special development in a printing machine.

Thus, in the production of a printing plate, appropriate calibrations, that is to say settings and checks of the optimal process parameters, must be carried out for that process.

A calibration of the dot and line printing plate exposure is described in European Patent EP 0 759 192 B1, corresponding to U.S. Pat. No. 5,748,331, which is fully incorporated herein by reference.

That presents a process control strip for the visual checking and calibration of an exposure process for a printing plate in a direct exposure of the printing plates in electronic recording appliances.

As is described in the disclosure of European Patent EP 0 759 192 B1, corresponding to U.S. Pat. No. 5,748,331, for that purpose, two parallel strips in the process control strip are exposed, which extend in each case in the direction of the greater extent of the process control strip.

The first strip has a tone value wedge as a line raster. That line raster represents approximate signal elements in the form of straight lines which are substantially independent of process fluctuations. Reference tone values change within that tone value wedge. That change may take place continuously or else in gradations, for example in 16 steps.

The second strip has a raster with fine raster dots as fine signal elements. That raster has a uniform highly process-dependent tone value.

One portion of the two strips is distinguished in such a way that, in the case of a “correct” calibration of the imagesetter, the tone values in the first and the second strip appear identical there. In order to check the actual state, what is detected first in that case is whether the region in which there is a visual identity of the tone values of the two strips lies in the predetermined portion. If that is not so, an adjustment, that is to say a setting, of the process parameters of the printing plate imagesetter must take place, until the region of tone value identity lies in the “correct” portion. Express incorporation is made herein by reference to EP 0 759 192 B1, corresponding to U.S. Pat. No. 5,748,331, for the exact execution of that method and for the configuration of the process control strip.

In the known prior art in which the lines have a course or run in a preferential direction, there is a problem which is that, depending on the location of the observer with respect to the exposed printing plate or to a correspondingly imaged print sheet, a different visual density impression is obtained, that is to say a different tone value is detected.

If a first observer looks at the printing plate from the direction of the preferential direction of the lines, that is to say in the direction of their course or run, for example from the leading edge of the printing plate, he or she will get an impression of the detected tone value different than if he or she looks at the same process control strip from the side edge of the printing plate.

In addition, it is also noticeable there, that, due to the rotation of the printing plate or of the exposure beam in the case of an indrum imagesetter, and due to tolerances in the optical system, no symmetrical pixels, that is to say dots, are exposed during the exposure operation. Instead, oval shapes occur. Those ovals are distorted in the fastscan direction. Different tone values of the lines of the tone value wedge are obtained, depending on whether the lines run in the fastscan or slowscan direction. Different identities of the tone values of the first and the second strips may be detected, together with the different visual impression of an observer, depending on his or her location in relation to the preferential direction, as described, which may be detrimental to the adjustment of the imagesetter.

### SUMMARY OF THE INVENTION

It is accordingly an object of the invention to provide a process control strip and a method for its exposure, which overcome, or at least reduce, the hereinafore-mentioned disadvantages of the heretofore-known devices and methods of this general type and with which a better adjustment of a printing plate imagesetter can be achieved.

With the foregoing and other objects in view there is provided, in accordance with the invention, a process control strip comprising at least one first region with coarse signal elements and at least one second region with fine signal values. The first and the second regions are to be at least partially contiguous to or border one another.

The at least one first region has a line raster with lines which have a course or run different from a straight line. Due to an alternating run of the lines, the orientation of the lines changes in terms of their direction of propagation, that is to say their preferential direction, at least in regions. This also allows a different run of the lines in relation to the direction of observation of an observer. Irrespective of whether the printing plate or a corresponding sheet is looked at from the fastscan direction or slowscan direction or from a leading edge or side edge, regions which appear virtually codirectional from any viewing direction are always obtained. This is also possible through the use of a line run in which the lines are interrupted in places, but in regions deviate in their run from the preferential direction, that is to say, insofar as they also deviate from a straight line, they also do not correspond in their run to the run of a straight line interrupted in places.

According to the invention, there is a provision for the first and second regions to extend in the direction of the greater extent of the process control strip, with the first strip being constructed with a tone value wedge having reference tone values changing in the strip direction, and the second region being constructed as a second strip running parallel to the first strip. The regions can thereby be compared with one another quickly and simply.

In accordance with another feature of the invention, in an alternative embodiment, a multiplicity of first regions, each with reference tone values which are specific, but are different in relation to one another, are provided, and a multiplicity of second regions with identical tone values are provided. In this case, they may have a substantially rectangular or square construction. There is then a number of first regions. These first regions differ in each case in their tone value and are contiguous to a second region. As required, these individual regions may then be distributed over the process control strip substantially independently of one another. This may lead, on one hand, to a space saving, but, on the other hand, desired visual improvements may also be achieved. There may be provision, for example, for a plurality of first regions having the same tone value to be provided, which differ from one another in the preferential direction of their lines.

In accordance with a further feature of the invention, the at least one first region and the at least one second region engage one in the other, at least in regions. In this way, an identity of the tone values of the first and second region can be detected even more simply. In particular, there is provision for precise parts of the first region which in each case differ in their tone values, but have a constant tone value in these parts, to project into a second region in such a way that they are substantially surrounded by this region, for example on three sides. For this purpose, the parts of the first region may extend, for example, in the form of obtuse triangles, into the second region. A similar effect can be achieved if parts of the second region project, preferably in the form of obtuse triangles, into parts of the first region which are of virtually constant tone value. These two configurations may also be provided simultaneously for the first and second region.

In accordance with an added feature of the invention, the lines of the line raster of the first region are oriented in a preferential direction and the lines form, at least in regions, an angle alpha relative to this preferential direction, which is different from zero. The visual impression of the process control strip can be further improved through the use of such a course or run.

In accordance with an additional feature of the invention, a sinusoidal, that is to say serpentine, course or run is provided for the course or run of the lines. A particularly preferred zigzag-shaped run may also be provided alternatively. The angle alpha which these lines form at least in portions with their preferential direction may, in this case, advantageously amount to 45 degrees. In most general terms, with such an alternating curvature behavior, the advantage is that the visual impression is independent of whether an observer stands at the side or at the front and observes a printing plate or a print sheet correspondingly. At the same time, the same visual impression arises, irrespective of whether the strip has been exposed in a direction perpendicular or horizontal with respect to the printing plate, that is to say in relation to the long side of the latter. Of course, instead of a print sheet, a portion of a paper web may be observed.

In accordance with yet another feature of the invention, in order to allow a better comparison between the tone values of the first region and the tone value of the second region, the preferential direction of the lines points substantially perpendicularly to a common contact surface of the first and second regions.

With the objects of the invention in view, there is also provided a method for exposing a process control strip. The method comprises providing a process control strip according to the invention and exposing the process control strip in dots and lines directly onto a printing plate.

In accordance with another mode of the invention, the process control strip is to be exposed onto the printing plate simultaneously with the dot and line exposure of the latter, as a result of which time can be saved.

In accordance with a further mode of the invention, the process control strip is oriented, during the dot and line exposure of the printing plate, in such a way that the preferential direction of the lines of the line raster in the first region runs in the line direction. As a result, in addition, a possibly residual influence of the elliptic dot shape of the exposure dots on the visual impression can be further reduced.

In accordance with a concomitant mode of the invention, an improvement in the independence of the viewing angle is also achieved in an alternative embodiment with a preferential direction of the lines of the line raster in the first region perpendicular to the line direction.

Other features which are considered as characteristic for the invention are set forth in the appended claims.

Although the invention is illustrated and described herein as embodied in a process control strip and a recording method, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, top-plan view showing a basic construction of a process control strip; and

FIG. 2 is a fragmentary, top-plan view of a process control strip with a first and a second region.

### DESCRIPTION OF THE PREFERRED EMBODIMENTS

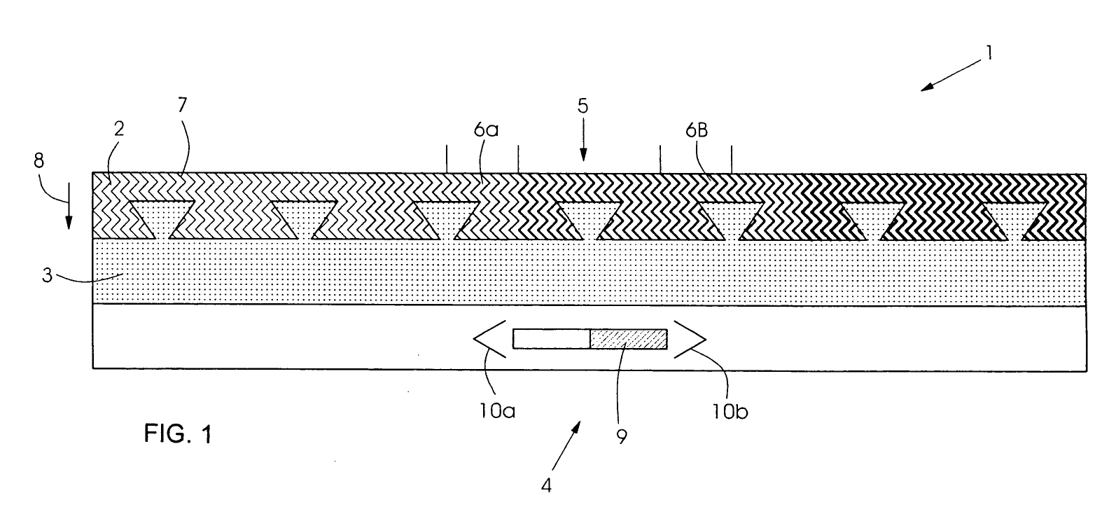

Referring now to the figures of the drawings in detail and first, particularly, to FIG. 1 thereof, there is seen a basic construction of a process control strip 1 for the direct exposure of printing plates through the use of an imagesetter (computer-to-plate).

During the direct exposure of the printing plate in the imagesetter, the process control strip 1 is exposed onto the printing plate outside a printing plate region provided for information to be exposed and is developed, together with the information, in a development station. The exposed and developed process control strip 1 serves for the visual checking and setting of process parameters, such as an intensity of a exposure beam and a development temperature and/or regeneration rates in the development station.

The process control strip 1 is formed basically of two strips, to be precise a desired value strip 2 and an actual value strip 3, which extend in the direction of the greater extent of the process control strip 1 and which are disposed parallel to one another. Moreover, a non-illustrated indicator strip may also be provided, which gives information on deviations from the desired operating point of the imagesetter. In the case illustrated herein, the process control strip 1 also includes a tolerance range 4.

In the exemplary embodiment, the desired value strip 2 is a stepped tone value wedge with, for example, 7 reference tone value steps in a range of ±7.5% tone value gradations around an optimal desired value range 5. The reference tone values of the tone value wedge are process-independent as far as possible, that is to say they change only insignificantly in the event of fluctuations of process parameters. Since a very fine raster is selected for generating the process control strip 1, a tone value gradation of 2.5% corresponds in this raster approximately to a tone value gradation of 1% in a conventional 60-raster. Consequently, in the desired value strip 2, tone value steps are indicated which represent a range of ±3% tone value gradations in relation to a 60-raster.

Within the tone value wedge of the desired value strip 1, the optimal desired value range 5 is fixed in such a way that it includes the reference tone value step which has the optimal operating point of the imagesetter. The tolerance range 4 is illustrated by an easily recognizable symbol and includes at least the optimal desired value range 5. In the case illustrated herein, desired value ranges 6a and 6b are also included, which, in the case of identity of the desired and actual value ranges, represent deviations of ±1% in the 60-raster. This tolerance range 4 is to be achieved in the exposure and development process on the printing plate. In this case, the reference tone value steps of the tone value wedge are expediently selected in such a way that the desired value range 5 required lies in the middle region of the process control strip 1. If a tone value accuracy of 1% is achieved in a conventional raster, the errors occurring due to the exposure of the printing plate in the printing process due to inaccuracies in the printing machine itself are generally below the detectable limit.

Instead of a tone value wedge with stepped reference tone values, a tone value wedge with continuously changing reference tone values may also be used.

The tone value wedge of the desired value strip 2 is constructed as a line raster with lines 7 which are oriented perpendicularly to the extent of the process control strip 1 and which are composed of individual pixels during exposure.

A preferential direction 8 of the lines 7 runs in the direction of this orientation. The lines 7 in this case each have a zigzag line shape and run parallel to one another. The reference tone values of the tone value wedge are defined by a ratio of line width to line interval of the line raster. The lines 7 of the tone value wedge represent coarse signal elements. The size of the coarse signal elements only insignificantly changes in the event of fluctuations of the process parameters, since the process-dependent changes of the pixel sizes substantially only in the preferential direction 8 or perpendicular thereto at the lateral edges of the lines 7 lead to negligible tone value changes. Individual straight part regions of the lines 7 with the preferential direction 8 and with a direction perpendicular thereto, form substantially the same angle alpha. Therefore, in the tone value growth of the lines 7, it is immaterial whether the preferential direction 8 lies parallel to the fastscan direction or the slowscan direction. The reference tone values of the desired value strip 2 are thereby substantially process-independent.

The structure of the line raster of the desired value strip 2 is selected in such a way that as homogenous an impression of a tone value range as possible is obtained. The resolution of the human eye is limited, and the line raster should be selected in such a way that the integrating action with respect to a homogenous impression is not lost. A beneficial value for the line raster is in a range of 20 lines in the case of the zigzag lines 7. An average value of 50% surface cover is then achieved in the case of 10 exposed lines and 10 unexposed lines. The actual shortest distance between the lines is advantageously achieved in this case not by a distance perpendicular to the preferential direction 8 but, instead, by the angles of the lines 7 whereby, in the case of a 45° angle of partial lines relative to the preferential direction 8, an angle of 45° in relation to the perpendicular of the preferential direction 8 is also formed. The actual effective distance between the lines is thereby reduced by a factor of about 0.7, with the result that finer and more homogenous illustrations of the tone value wedge become possible. The distance between the lines which is illustrated in FIG. 1 is greatly exaggerated, so that individual lines 7 are clearly recognizable. The width of a region of the desired value strip 2 with a constant tone value amounts to about 8 mm. The gradation of the tone value wedge is achieved through the use of increasing widths of the lines 7.

The actual value strip 3 running parallel to the desired value strip 2 is finely screened, for example with fine raster cells with 4×4 pixels and represents a highly process-dependent, but uniform tone value within the actual value strip 3. The actual value strip 3 is formed of a multiplicity of fine raster dots disposed in a raster, wherein each fine raster dot in a fine raster cell is composed of individual exposed pixels during exposure. The sum of the exposed pixel areas or the fine raster dot size within a fine raster cell in relation to the overall area of the fine raster cell determines the exposed tone value. The exposed pixels or the fine raster dots composed of the exposed pixels within the actual value strip 3 form fine signal elements, the size of which changes in the event of fluctuations of the process parameters, with the result that process-dependent tone value changes occur.

In order to achieve high tone value changes, each raster dot is expediently exposed from a comparatively large number of pixels available within a fine raster cell of the raster, for example from 3×3 exposed pixels within a fine raster cell constructed from 4×4 pixels. These fine raster dots thus give a tone value of 56.25%. In this range, tone value changes are easily recognizable by the human eye. In general, therefore, the aim is to have a tone value in the region of the fine raster cells of about 50%, and this may, for example, be a value from the interval of 40% to 60%. The optimal average tone value achievable may in this case depend on the size of the fine raster cell.

A process-dependent pixel size change brings about a comparable high change in the percentage area fraction of the overall area of a fine raster cell, so that, in the case of pixel size changes due to fluctuations of the process parameters, high tone value changes occur within the actual value strip 3.

The structure of the raster in the actual value strip 3 with respect to the size of the fine raster cell and the size and shape of the fine raster dots, is limited by the resolution of the printing plate to be exposed and is therefore dependent on the plate type and additionally on the addressing during raster dot generation as well. Practical values are 3 to 5 times the addressing for the side length of a fine raster cell assumed to be square.

Each pixel size or fine raster dot size exposed on the actual value strip 3 of the process control strip 1 thus represents a tone value which is achieved in the exposure process and which is identical to a reference tone value of the tone value wedge of the desired value strip 2.

The nominal condition for the exposure process is fulfilled when the tone value achieved in the actual value strip 3 falls within the defined optimal desired value range 5 of the desired value strip 2. Since a tone value of 56.25% is achieved nominally in the actual value strip 3, the line distribution in the optimal desired value range 5 is selected in such a way that it comes nearest to this tone value. An exposure of 11 lines to 9 unexposed lines, achieves a tone value of 55% in this range. In practice, the tone value in the optimal desired value range 5 is fixed, taking into account the plate type, process reliability and the Yule-Nielsen effect acting differently in the desired and the actual value range.

If the process parameters change, the tone value of the actual value strip 3 changes, while the tone values of the tone value wedge in the desired value strip 2 of the process control strip 1 remain virtually stable. In the event of a change in the process parameters, the identity of the tone values occurs at another point on the process control strip 1.

In order to provide simple visual checking of the degree of tone value identity, the process control strip 1 has a tolerance range 4 which runs parallel to the desired value strip 2 and to the actual value strip 3 and which has graphic symbols disposed one behind the other in the longitudinal direction of the strip. Through the use of a black-and-white bar 9, the run of the tone value wedge from light to dark is indicated, and pointed brackets 10a and 10b illustrate the limits of the tolerance range 4 and determine the desired value ranges 6a, 6b which still lie within the tolerance range 4. In this way, advantageously, location-dependent evidence is obtained from the process control strip (\1 as to whether the printing plate is correctly exposed, overexposed or underexposed, depending on whether a visual identity of the tone value of the actual value strip 3 with a region of the desired value strip 2 is detected in the darker region or in the lighter region of the process control strip 1.

The same tone value is always detected in the actual value strip 3 and in the desired value strip 2, independently of the viewing direction of an observer of this process control strip 1. This, on one hand, is because of the nature of the actual value strip 3, since it is constructed as a dot raster. For the desired value strip 2, the tone value independent of the viewing angle is achieved through the use of the zigzag shape of the lines 7. Irrespective of whether the observer looks at the process control strip 1 from the direction of the preferential direction 8 or perpendicularly thereto, substantially the same number of partial regions of the lines 7 run at an angle of ±45 degrees to the observation direction if, as in the case illustrated, the angle alpha of the partial regions amounts to 45 degrees to the preferential direction 8 between two tips of the lines 7. Thus, the visual impression of an observer is independent of whether he or she looks at a printing plate having a process control strip 1 or at a correspondingly imaged sheet from the leading edge or from the side edge. Furthermore, basically, it is therefore also unimportant whether the process control strip 1 is imaged in the region of the side edge or the leading edge of a printing plate. The viewing angle for the process control strip 1 no longer has to be taken into account when it is positioned on the print master copy during pagination (impositioning).

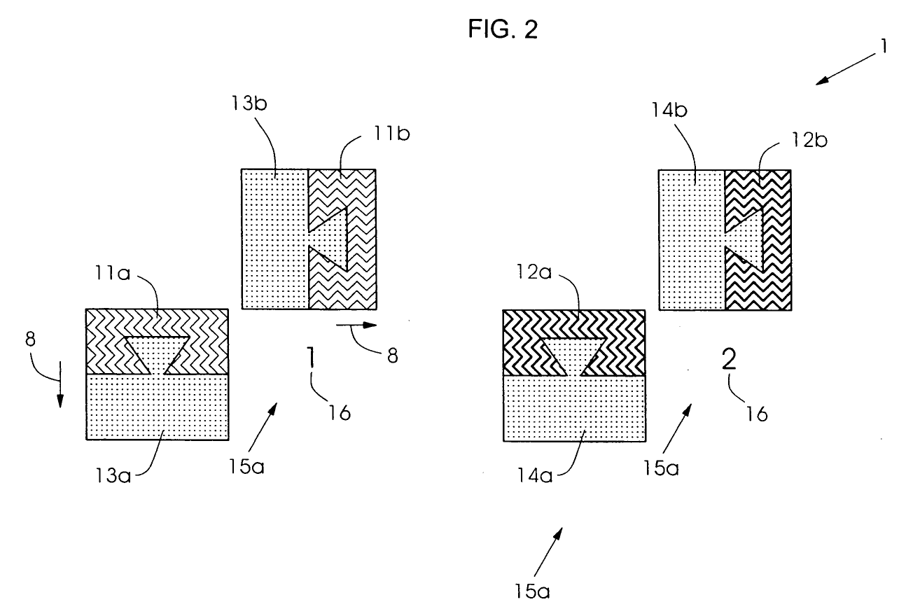

FIG. 2 shows an alternative possibility for the configuration of first regions 11a, 11b, 12a, 12b with at least partially different tone values for the process control strip 1. The first regions are contiguous to second regions 13a, 13b, 14a, 14b in each case with the same tone value. The second regions 13a, 13b, 14a, 14b are constructed in the same way as the desired value strip 2 and have the same properties as those described with regard to FIG. 1. This is a portion or detail of a complete process control strip 1 which also includes further first and second regions, not illustrated herein.

The first and second regions 11a, 11b and 13a, 13b as well as 12a, 12b and 14a, 14b are intermeshed in the same way as the desired value strips 2 and actual value strip 3 in FIG. 1.

For this purpose, the individual second regions 13a, 13b, 14a, 14b have outgrowths which correspond to the shape of trapezia that project into the first regions 11a, 11b, 12a, 12b. This shaping may also be interchanged.

As is illustrated herein, the first regions 11a, 11b and 12a, 12b have the same tone values in each case, but differ from one another, that is to say the tone values of the first regions 11a, 11b and those of the first regions 12a, 12b differ from one another. The same applies to further first regions, not illustrated herein, of the process control strip 1, which in each case differ from one another in pairs in terms of their tone values. The first regions 11a, 11b, 12a, 12b and the first regions which are not shown herein map the tone value wedge of the desired value strip 2 of FIG. 1.

The first regions 11a, 11b and 12a, 12b together with the second regions 13a, 13b and 14a, 14b, in each case form rectangular reference elements 15a and 15b. These reference elements 15a, 15b are oriented in each case in the preferential direction 8 of the lines 7. The reference elements 15a and 15b assume positions offset perpendicularly to one another in relation to the orientation of the printing plate, that is to say in relation to a preferential direction such as, for example, the fastscan direction. The influence of the writing direction or of the observation direction on the visual impression can thereby be reduced even further.

In order to provide for the better assignment of the reference elements 15a, 15b to overexposed or underexposed regions, there is provision for directly assignable markings 16 to be located in their surroundings. As is illustrated herein, these may be formed, for example, of numerals which lie, for example, in a range ±3 and thus describe corresponding deviations of the imagesetter from the optimal desired value range which would be marked herein by 0. It is also possible to directly use desired value undershooting, desired value overshooting and desired value reached as markings.

In the case illustrated herein, the reference elements 15a, 15b occur in pairs. It is, of course, also possible, however, to provide only one reference element 15a or 15b in each case which then possesses a preferential direction 8 of the lines 7 either parallel or perpendicular to a preferential direction of the printing plate.

Irrespective of whether the process control strip 1 includes the first and the second region in the form of different independent regions 11a, 11b, 12a, 12b, 13a, 13b, 14a, 14b or in each case as a region in the form of the desired value strip 2 and of the actual value strip 3, it is always possible to judge the tone value identity of the first and second region independently of the viewing angle and thus to obtain visual information as to whether the process parameters are set in such a way that the imagesetter operates in the tolerance range 4 or whether overexposure or underexposure is taking place.

We claim:

1. A process control strip for the visual checking of an exposure process for recording material in the form of a printing plate, the process control strip comprising:
at least one first region including coarse signal elements having process-independent reference tone values changing within the process control strip, said coarse signal elements having a size being substantially constant in the event of process fluctuations, and said at least one first region being formed as a line raster with lines having a course different from a straight line;
at least one second region including fine signal elements having a raster with fine raster dots representing a uniform highly process-dependent tone value in said at least one second region, said fine signal elements having a size changing in the event of process fluctuations; and
said at least one first region and said at least one second region being at least partially contiguous to one another.

2. The process control strip according to claim 1, wherein:
said at least one first region is a multiplicity of first regions each having reference tone values being specific but different relative to one another; and
said at least one second region is a multiplicity of second regions with identical tone values.

3. The process control strip according to claim 2, wherein said first and second regions have a substantially rectangular or square structure.

4. The process control strip according to claim 1, wherein:
said first region is constructed as a first strip extending in a direction of a greater extent of said process control strip and having a tone value wedge with reference tone values changing in said strip direction; and
said second region is constructed as a second strip running parallel to said first strip.

5. The process control strip according to claim 1, wherein said at least one first region and said at least one second region engage in one another at least regionally.

6. The process control strip according to claim 1, wherein said lines of said line raster are oriented in a preferential direction, and said lines enclose, at least regionally, an angle alpha relative to said preferential direction being different from zero.

7. The process control strip according to claim 6, wherein said lines have a substantially sinusoidal course.

8. The process control strip according to claim 6, wherein said lines have a substantially zigzag-shaped course.

9. The process control strip according to claim 6, wherein said angle alpha between substantially straight segments of said lines is about 45 degrees.

10. The process control strip according to claim 7, wherein said angle alpha between substantially straight segments of said lines is about 45 degrees.

11. The process control strip according to claim 8, wherein said angle alpha between substantially straight segments of said lines is about 45 degrees.

12. The process control strip according to claim 6, wherein said first and second regions have a common contact surface, and said preferential direction of said lines is substantially perpendicular to said common contact surface.

13. The process control strip according to claim 7, wherein said first and second regions have a common contact surface, and said preferential direction of said lines is substantially perpendicular to said common contact surface.

14. The process control strip according to claim 8, wherein said first and second regions have a common contact surface, and said preferential direction of said lines is substantially perpendicular to said common contact surface.

15. The process control strip according to claim 9, wherein said first and second regions have a common contact surface, and said preferential direction of said lines is substantially perpendicular to said common contact surface.

16. The process control strip according to claim 10, wherein said first and second regions have a common contact surface, and said preferential direction of said lines is substantially perpendicular to said common contact surface.

17. The process control strip according to claim 11, wherein said first and second regions have a common contact surface, and said preferential direction of said lines is substantially perpendicular to said common contact surface.

18. A method for exposing a process control strip, the method comprising the following steps:
providing the process control strip according to claim 1; and
exposing the process control strip in dots and lines directly onto a printing plate.

19. The method according to claim 18, which further comprises carrying out the exposure of the process control strip simultaneously with the dot and line exposure of the printing plate.

20. The method according to claim 18, which further comprises, during the dot and line exposure of the printing plate, orienting the process control strip with a preferential direction of the lines of the line raster in the first region extending in the line direction.

21. The method according to claim 19, which further comprises, during the dot and line exposure of the printing plate, orienting the process control strip with a preferential direction of the lines of the line raster in the first region extending in the line direction.

22. The method according to claim 18, which further comprises, during dot and line exposure of the printing plate, orienting the process control strip with a preferential direction of the lines of the line raster in the first region extending perpendicularly to the line direction.

23. The method according to claim 19, which further comprises, during dot and line exposure of the printing plate, orienting the process control strip with a preferential direction of the lines of the line raster in the first region extending perpendicularly to the line direction.
